(19) United States
(12) Patent Application Publication
(10) Pub. No.: US 2023/0096295 A1
(43) Pub. Date: Mar. 30, 2023

(54) Collapsible and Transportable Parallel Bar Assembly

(71) Applicant: Angel Sanders, Pooler, GA (US)

(72) Inventor: Angel Sanders, Pooler, GA (US)

(21) Appl. No.: 17/937,362

(22) Filed: Sep. 30, 2022

Related U.S. Application Data
(60) Provisional application No. 63/250,976, filed on Sep. 30, 2021.

(51) Int. Cl. A61H 3/00; A63B 3/00

(52) U.S. Cl. CPC A61H 3/00; A63B 3/00; A61H 2201/0157; A61H 2201/0161; A61H 2201/013; A61H 2201/169

(57) ABSTRACT

A portable physical therapy system for remote physical therapy and related methods. The system includes collapsible bars that are hingedly attachable to handrails, and the collapsible bars are securable at any of a plurality of lengths. The system also includes bar feet, and each bar foot secures a collapsible bar or a base thereon and securely engages a surface thereunder. The lower portion of the bar foot includes a suction cup to secure the bar foot to the surface by suction. The system may be folded up into the base which functions as a carrying case for storage or transport of the system and may be unfolded and assembled as a set of parallel bars, a pull bar, or another configuration for physical therapy and rehabilitation.

### RELATED APPLICATIONS

This is a non-provisional application which claims priority to U.S. Provisional Application No. 63/250,976 filed Sep. 30, 2021 under provisions of 35 U.S.C. § 119(e). The disclosure of the prior application is hereby incorporated by reference herein in its entirety.

### FIELD

The disclosure relates to a portable physical therapy device or system for remote physical therapy. A portable therapy system is configurable as a set of parallel bars or a pull bar, according to need, and may be combined with a walker to provide increased stability for standing exercises. The therapy system may be attached to a floor or a wall during use and may be folded and stored or transported in a carry case when not in use.

### BACKGROUND

Many individuals need rehabilitative physical therapy when recovering from injury, surgery, or as part of limiting the impact of aging or disease on health and daily life. However, many such individuals are unable to attend therapy sessions at a rehabilitative facility due to such facilities being outside these individuals' available range of travel. In addition, many professional rehabilitative physical therapists work with their patients at the patient's home or other space and would benefit from being able to bring necessary equipment to such spaces without creating a permanent fixture at these spaces. Walkers and other existing portable physical therapy devices provide a limited scope of activities which they are useful for, and patients that use these devices do not obtain the benefit of other activities which may be more detailed, intense, and beneficial.

Accordingly, there is a need for a portable physical therapy system that can be transported to a remote space and used by an individual for detailed or intense exercises and therapy activities. The present invention addresses this unmet need.

### SUMMARY

In one aspect, the disclosure provides a portable therapy system, comprising a plurality of collapsible bars, wherein each collapsible bar is hingedly attachable to a handrail and is securable at any of a plurality of lengths; and a plurality of bar feet, wherein each bar foot includes an upper portion to secure an object and a lower portion to secure the bar foot to a surface. The object may be a collapsible bar, and the upper portion of each bar foot may include a bar depression configured to accept and secure a collapsible bar therein. Alternatively, or in addition, the object may be a base that comprises a left portion hingedly affixed to a right portion, such that the base is foldable and functions as a carrying case for transporting the portable therapy system. In such implementations, the base may comprise a bar depression thereon configured to accept and secure a collapsible bar therein. In implementations, the base may include a non-slip coating thereon to prevent the individual from slipping on the base during use.

In various implementations, the lower portion of each bar foot includes a suction cup to secure the bar foot to the surface by suction. In this manner, the system may be secured to any suitable surface, including but not limited to a floor and a wall, and may be configured as needed for a particular therapy activity. In certain instances, each suction cup comprises a suction pump for creating a vacuum within a space between the suction cup and the surface and a suction release for releasing the vacuum within the space between the suction cup and the surface. In such cases the suction cups may be particularly sturdy for maintaining the seal and the vacuum and securing the system in place during therapy.

In implementations, the system includes a plurality of handrails, and each handrail is hingedly attachable to each collapsible bar. In implementations, each handrail comprises a non-slip gel grip thereon so that the individual can effectively grip the handrail without slipping and falling during therapy.

The collapsible bars may be implemented in any of a variety of manners, but in certain instances, each collapsible bar includes a male portion and a female portion, and the male portion is insertable into the female portion. A plurality of holes of the male portion are alig nable with a plurality of holes of the female portion to secure a position of the male portion relative to the female portion by insertion of a lock bar through aligned holes. In this manner a height of the handrails may be adjusted to accommodate different-sized and different-abled individuals.

The invention generally relates to an improved portable therapy system which may be manufactured with appropriate materials and processes and which may be scaled as needed.

Other objects, features, and advantages of the invention will become apparent from the following detailed description taken in conjunction with the accompanying drawings.

### BRIEF DESCRIPTION OF THE DRAWINGS

Although the characteristic features of the invention will be particularly pointed out in the claims, the invention itself and manners in which it may be made and used may be better understood after a review of the following description, taken in connection with the accompanying drawings, wherein like numeral annotations are provided throughout.

FIG. 1 depicts a side view of a portable therapy system configured as a set of parallel bars.

FIG. 2 depicts a side view of the portable therapy system being broken down to a disassembled configuration.

FIG. 3 depicts a side view of the portable therapy system in the disassembled configuration.

FIG. 4 depicts a top view (upper) and a bottom view (lower) of a suction cup of a bar foot of the portable therapy system.

FIG. 5 depicts a view of an upper side of a base of the portable therapy system.

FIG. 6 depicts a view of a lower side of the base of the portable therapy system.

FIG. 7 depicts an exemplary use of the portable therapy system.

### DETAILED DESCRIPTION OF THE INVENTION

Reference is made herein to the attached drawings. Like reference numerals may be used in the drawings to indicate like or similar elements of the description. The figures are intended for representative purposes and should not be considered limiting.

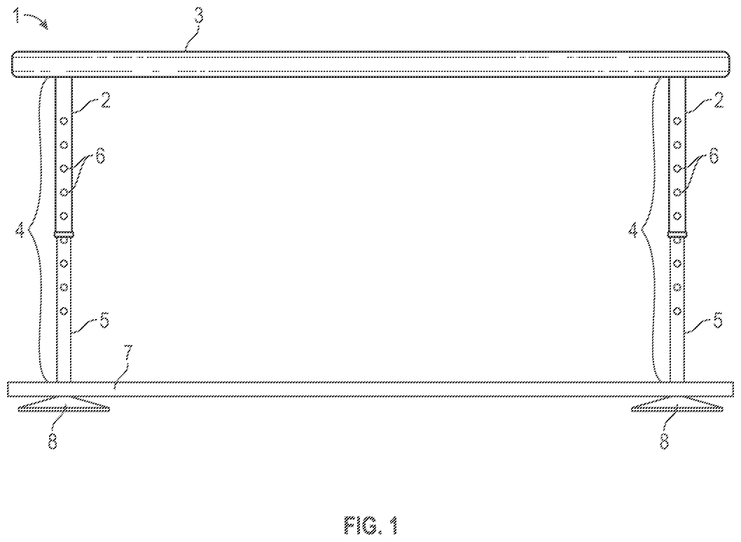

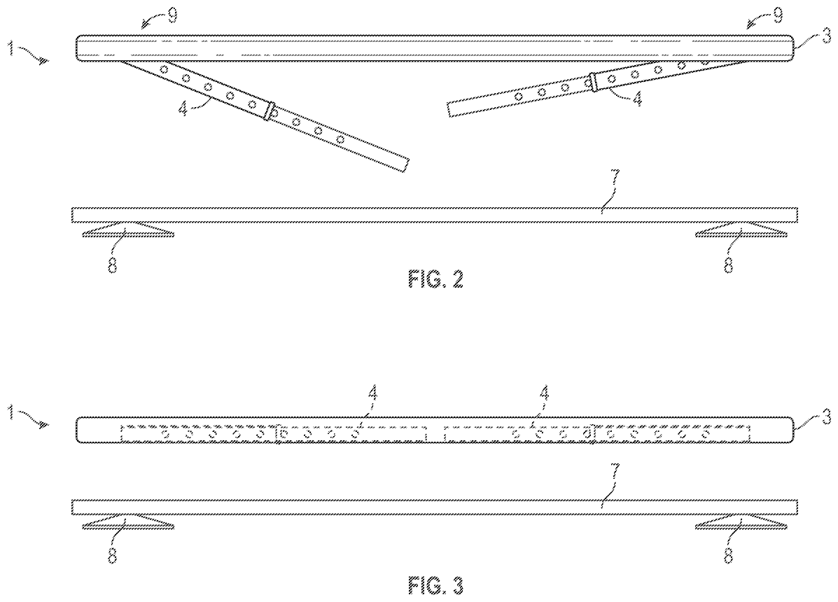

Referring now to FIGS. 1, 2, and 3, there are depicted side views of a portable therapy system assembled and configured as a set of parallel bars (FIG. 1), being broken down to a disassembled configuration (FIG. 2), and in the disassembled configuration (FIG. 3). A portable therapy system 1 comprises a plurality of collapsible bars 4, and each collapsible bar 4 is hingedly attachable or attached to a handrail 3 and is securable or secured at any of a plurality of lengths. The portable therapy system 1 includes a plurality of bar feet 8, and each bar foot includes an upper portion to secure an object, such as a base 7, and a lower portion to secure the bar foot 8 to a surface such as a floor or, in certain implementations, a wall or another surface.

In the shown embodiment, the object secured by the bar foot is the base 7, but in some instances, the object secured by the bar foot is the collapsible bar 4. Specifically, the bar foot 8 may directly engage the collapsible bar 4, for example in assemblies that do not include the base 7 or may indirectly engage the collapsible bar 4 via the base 7 which is present in such other assemblies. In implementations wherein the object secured may be the collapsible bar 4, the upper portion of each bar foot 8 may include a bar depression configured to accept and secure a collapsible bar 4 therein. In implementations wherein the object secured may be the base, the base may comprise a bar depression thereon configured to accept and secure a collapsible bar 4 therein.

The collapsible bars 4 may be implemented in any of a variety of manners, but in certain instances, each collapsible bar 4 includes a male portion 5 and a female portion 2, and the male portion 5 is insertable into the female portion 2. A plurality of holes 6 of the male portion are align able with a plurality of holes 6 of the female portion to secure a position of the male portion 5 relative to the female portion 2 by insertion of a lock bar (not shown) through aligned holes 6. In this manner, a height of the handrails 3 may be adjusted to accommodate different-sized and different-abled individuals.

To transition the portable therapy system from an assembled configuration (FIG. 1) to a disassembled configuration (FIG. 3), the collapsible bars 4 are detached from the base 7 or the bar feet 8 and are folded inward at hinges 9 that hingedly connect the collapsible bars 4 with the handrails 3 (FIG. 2). The lengths of the collapsible bars 4 may be too long for such folding, and in such instances, may be decreased by removing the lock bar from the aligned holes and sliding the male portion 5 within the female portion 2 as needed before the inward folding. Thereafter, the collapsible bars 4 are parallel or substantially parallel with the handrails 3 and the components of the portable therapy system 1 may be more compact and able to be stored and transported between locations.

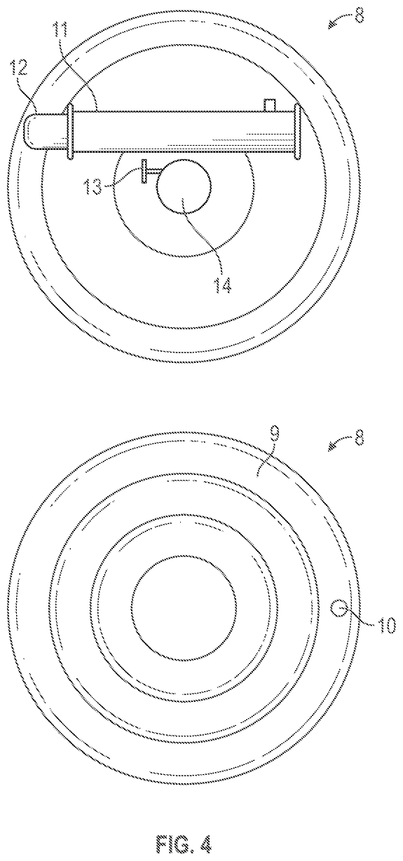

Referring now to FIG. 4, there is depicted a top view (upper) and a bottom view (lower) of a suction cup of a bar foot of the portable therapy system. In various implementations, the lower portion of each bar foot 8 includes a suction cup 9 to secure the bar foot 8 to the surface by suction. In this manner, the system may be secured to any suitable surface, including but not limited to a floor and a wall, and may be configured as needed for a particular therapy activity.

In certain instances, each suction cup 9 comprises a suction pump 11 for creating a vacuum within a space between the suction cup 9 and the surface and a suction release 13 for releasing the vacuum within the space between the suction cup 9 and the surface. In such cases the suction cups 9 may be particularly sturdy for maintaining the seal and the vacuum and securing the system in place during therapy. The suction pump may comprise a button 12 which may be pulled and/or pressed to actuate a piston and displace air out of the space between the suction cup 9 and the surface, through a suitable valve (not shown), and out of the suction pump and into an environment. The piston may be fluidly connected to the space by a vacuum pump aperture 10 positioned on the suction cup 9. When the suction release 13 is actuated, the suitable valve may be altered and the air may return from the environment to the space between the suction cup 9 and the surface thereby causing the vacuum to be lost and the bar foot to become detached from the surface.

In embodiments, an upper portion of the bar foot 8 comprises a bar depression 14 for directly receiving and securing a collapsible bar therein. In such instances, if the collapsible bar is inserted into the bar depression 14 of the bar foot 8, outer portions of the bar foot 8 may automatically close around the collapsible bar and increase pressure against the collapsible bar and provide an improved grip thereto. In this manner, the collapsible bar is more stably secured to the surface by the bar foot 8.

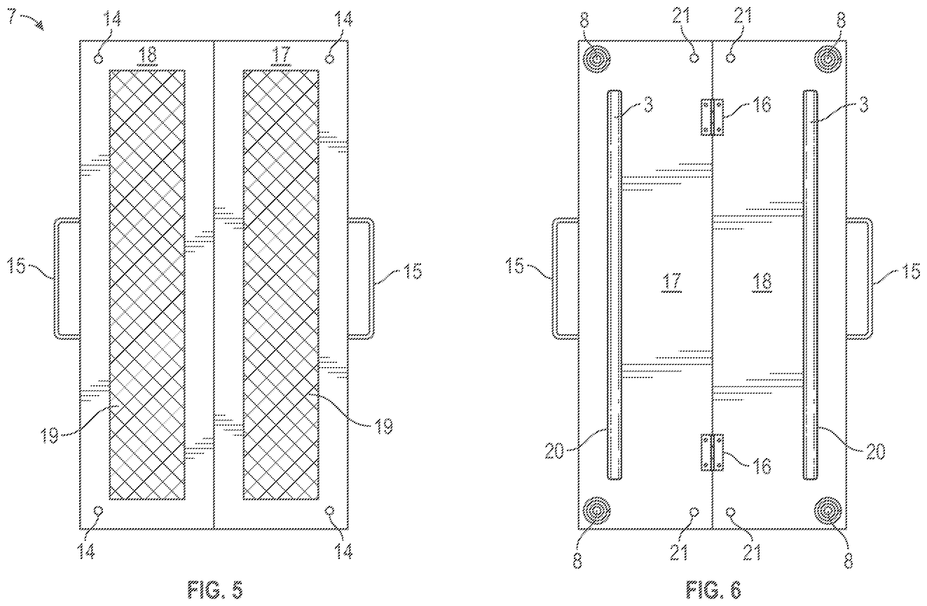

Referring now to FIGS. 5 and 6, there are depicted views of an upper side (FIG. 5) and a lower side (FIG. 6) of a base of the portable therapy system. In implementations, the base 7 may comprise a left portion hingedly affixed (e.g., via hinges 16) to a right portion, such that the base 7 is foldable and functions as a carrying case for transporting the portable therapy system. In implementations, the base 7 may include a non-slip coating 19 thereon to prevent the individual from slipping on the base 7 during use. In implementations, the system includes a plurality of handrails 3, and each handrail 3 is hingedly attachable or attached to each collapsible bar (not shown). In implementations, each handrail 3 comprises a non-slip gel grip 20 thereon so that the individual can effectively grip the handrail 3 without slipping and falling during therapy.

In implementations, the base 7 includes one or more handles 15 for transporting the system. The bar feet 8 may be arranged on the base 7 adjacent to a plurality of wheels 21, also for transporting the system. In implementations, the upper side of the base 7 includes a plurality of bar depressions 14 each configured to accept and secure a collapsible bar therein. In this implementation, the collapsible bars may be secured to the bar depressions 14 of the base 7, and the bar feet 8 may be secured to the surface to hold the base 7 stationary relative to the surface during use of the system.

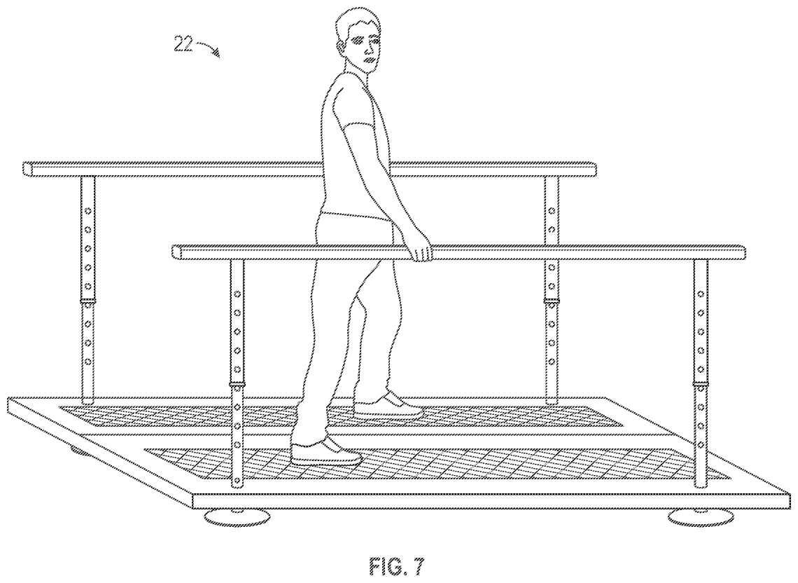

Referring now to FIG. 7, there is depicted an exemplary use of the portable therapy system. In the shown assembly, the portable therapy system is configured as parallel bars, but in other assemblies, may be configured as a pull bar or another configuration for physical therapy and rehabilitation. As the system may be easily disassembled, stored, transported, and reassembled, the system is more portable and more useful compared to existing physical therapy devices and systems. In this manner, a greater number of patients and individuals may benefit from improved access to physical therapy, even when remote.

The foregoing descriptions of specific embodiments of the present invention have been presented for purposes of illustration and description. They are not intended to be exhaustive or to limit the present invention to the precise forms disclosed, and modifications and variations are possible in view of the above teaching. The exemplary embodiment was chosen and described to best explain the principles of the present invention and its practical application, to thereby enable others skilled in the art to best utilize the present invention and its embodiments with modifications as suited to the use contemplated.

It is therefore submitted that the present invention has been shown and described in the most practical and exemplary embodiments. It should be recognized that departures may be made which fall within the scope of the invention. With respect to the description provided herein, it is submitted that the optimal features of the invention include variations in size, materials, shape, form, function and manner of operation, assembly, and use. All structures, functions, and relationships equivalent or essentially equivalent to those disclosed are intended to be encompassed by the present invention.

The following is claimed:

1. A portable therapy system, comprising:
a plurality of collapsible bars, wherein each collapsible bar is hingedly attachable to a handrail and is securable at any of a plurality of lengths; and
a plurality of bar feet, wherein each bar foot includes an upper portion to secure an object and a lower portion to secure the bar foot to a surface.

2. The portable therapy system of claim 1, wherein the object is a collapsible bar, wherein the upper portion of each bar foot comprises a bar depression configured to accept and secure a collapsible bar therein, and wherein the lower portion of each bar foot comprises a suction cup to secure the bar foot to the surface by suction.

3. The portable therapy system of claim 1, wherein the object is a base, wherein an upper side of the base comprises a bar depression configured to accept and secure a collapsible bar therein, wherein the base comprises a left portion hingedly affixed to a right portion, and wherein the base is foldable and functions as a carrying case for transporting the portable therapy system.

4. The portable therapy system of claim 1, further comprising a plurality of handrails and wherein the handrail is one of the plurality of handrails, wherein each handrail is hingedly attachable to each collapsible bar.

5. The portable therapy system of claim 4, wherein each handrail comprises a non-slip gel grip thereon.

6. The portable therapy system of claim 1, wherein the object is a base configured to secure the plurality of collapsible bars thereon.

7. The portable therapy system of claim 6, further comprising the base.

8. The portable therapy system of claim 7, wherein the base comprises a non-slip coating thereon.

9. The portable therapy system of claim 1, wherein each collapsible bar comprises a male portion and a female portion, wherein the male portion is insertable into the female portion.

10. The portable therapy system of claim 9, wherein a plurality of holes of the male portion are align able with a plurality of holes of the female portion to secure a position of the male portion relative to the female portion by insertion of a lock bar through aligned holes.

11. The portable therapy system of claim 1, wherein each lower portion of each bar foot comprises a suction cup to secure the bar foot to the surface by suction.

12. The portable therapy system of claim 11, wherein each suction cup comprises a suction pump for creating a vacuum within a space between the suction cup and the surface and a suction release for releasing the vacuum within the space between the suction cup and the surface.

13. A portable therapy system, comprising:
a base with a plurality of bar feet attached thereunder and extending therefrom to secure the base to a surface;
a plurality of handrails; and
a plurality of collapsible bars attachable to an upper portion of the base and hingedly attached to the plurality of handrails.

14. The portable therapy system of claim 13, wherein the base comprises a left portion hingedly affixed to a right portion, wherein the base is foldable and functions as a carrying case for transporting the portable therapy system.

15. The portable therapy system of claim 13, wherein each collapsible bar comprises a male portion and a female portion, wherein the male portion is insertable into the female portion, wherein a plurality of holes of the male portion are align able with a plurality of holes of the female portion to secure a position of the male portion relative to the female portion by insertion of a lock bar through aligned holes.

16. The portable therapy system of claim 13, wherein each lower portion of each bar foot comprises a suction cup to secure the bar foot to the surface by suction, wherein each suction cup comprises a suction pump for creating a vacuum within a space between the suction cup and the surface and a suction release for releasing the vacuum within the space between the suction cup and the surface.

17. A portable therapy system, comprising:
a base with a plurality of bar feet attached thereunder and extending therefrom to secure the base to a surface, wherein the base comprises a left portion hingedly affixed to a right portion, wherein the base is foldable and functions as a carrying case for transporting the portable therapy system, wherein each lower portion of each bar foot comprises a suction cup to secure the bar foot to the surface by suction, wherein each suction cup comprises a suction pump for creating a vacuum within a space between the suction cup and the surface and a suction release for releasing the vacuum within the space between the suction cup and the surface;
a plurality of handrails; and
a plurality of collapsible bars attachable to an upper portion of the base and hingedly attached to the plurality of handrails, wherein each collapsible bar comprises a male portion and a female portion, wherein the male portion is insertable into the female portion, wherein a plurality of holes of the male portion are align able with a plurality of holes of the female portion to secure a position of the male portion relative to the female portion by insertion of a lock bar through aligned holes.

18. The portable therapy system of claim 17, wherein each handrail comprises a non-slip gel grip thereon, and wherein the base comprises a non-slip coating thereon.
